(19) United States
(12) Patent Application Publication
(10) Pub. No.: US 2005/0106529 A1
(43) Pub. Date: May 19, 2005

(54) Dental impression tray with detachable portions

(75) Inventors: Amir Abolfathi, Menlo Park, CA (US); Robert E. Tricca, Danville, CA (US); Eric Kuo, Foster City, CA (US)

Correspondence Address: ALIGN TECHNOLOGY, INC.;ATTENTION: BAO Q. TRAN, 881 MARTIN AVENUE, SANTA CLARA, CA, 95050, US

(73) Assignee: ALIGN TECHNOLOGY, INC., Santa Clara, CA (US)

(21) Appl. No.: 10/717,797

(22) Filed: Nov. 19, 2003

(51) Int. Cl. A61C 9/00

(52) U.S. Cl. 433/41

(57) ABSTRACT

A dental tray to receive a dental impression material thereon includes a base having a plurality of prongs the base having one or more openings to allow flowing of the dental impression material; a first wall extending from one side of the base, the first wall having one or more openings to allow flowing of the dental impression material; and at least one detachable portion formed on one end of one prong, the detachable portion being removable to shorten the prong length.

### BACKGROUND

The present invention relates generally to dental impression trays.

In dental applications, an impression is often used to create an imprint or negative likeness of the teeth and adjacent portions of the jaw (e.g., tooth formations, the contour of the gums, etc.) preparatory to dental repair, orthodontics and restoration of missing dental structures. Impressions are typically made by placing a soft, semi-fluid material within the confines of an open trough or channel of an arcuate tray which is then positioned within the mouth of a patient, thus allowing the material to set or cure. Depending upon the material used, the set impression may be either hard or have some elastic characteristics.

To provide the most accurate articulation, the impression cast should generally represent the entire dental arch. In this regard, the impression cast can be used to establish inter-proximal contacts, buccal and lingual contours and occlusion with the opposing teeth. From the negative or female cast of the teeth and surrounding structures, a positive reproduction or male cast may be created for the purpose of fabricating inlays, crowns, bridge retainers, dentures, restorations or the like.

Traditionally, before an impression cast of the dentition is created, a stock tray is selected by the dentist or dental assistant that will generally fit the dental arch of the particular patient. Since the dental arch may differ widely from patient to patient, various sizes of impression trays (e.g., small, medium and large) were developed by those skilled in the art to accommodate various mouth sizes, bite radii of teeth and to correspond to upper and lower anterior or quadrant impression sites.

As described in U.S. Pat. No. 6,629,841, certain dental impression trays formed of metal, such as stainless steel, have a pair of spaced-apart vertical walls joined by a semi-rigid mat or mesh material disposed horizontally between the opposing vertical walls. Extending outwardly in structural relation to at least a portion of the surface facing of one of the vertical walls, a handle member may be provided to facilitate a means for gripping the impression tray for purposes of manual manipulation. In addition, an open trough or channel is generally formed between the opposing vertical walls, wherein the horizontally disposed mesh material provides porous surface flooring for the trough. In operation, the mesh material provides a means for permitting excess flow of impression material to become displaced and extruded there through. Dental impression trays of the prior art may further include openings formed in the vertical walls of the trough or channel which generally function as an anchoring surface for the impression, thus allowing the excess flow of impression material to become attached thereto.

### SUMMARY

In one aspect, a method to create a digital model of a patient's teeth includes taking an impression of the patient's teeth using a dental tray containing a radiopaque material; scanning the impression and the dental tray using a radiographic source; and generating the digital model with scanned data.

In another aspect, a dental impression system includes a dental tray containing a radiopaque material adapted to receive a dental impression material thereon. The tray includes a base having a plurality of prongs, the base having one or more openings to allow flowing of the dental impression material; a wall extending from one side of the base, the wall having one or more openings to allow flowing of the dental impression material. A container houses the radiographic tray, both of which are then adapted to be scanned by a radiographic scanner.

In yet another aspect, a system to create a digital model of a patient's teeth includes a dental tray containing a radiopaque material adapted to take an impression of the patient's teeth; a radiation source; a scintillator to receive the radiation from the radiation source; a radiation detector coupled to the scintillator; a rotatable table positioned between the radiation source and the scintillator, the table being adapted to support the dental tray with the impression of the patient's teeth; and a computer coupled to the detector to generate the digital model with scanned data.

Advantages of the system may include one or more of the following. The dental tray's detachable portions allow the trays to be customized to the patient's particular physiology. The dental tray's detachable portions can be snapped off during use to accommodate various mouth sizes, bite radii of teeth, and to correspond to upper, lower, anterior, quadrant, or triple bite impression sites. The adjustable dental impression tray is formed of a disposable material, thus avoiding the disadvantages associated with having to clean and sanitize metal impression trays. The adjustable dental impression tray may be adjusted to the specific size of the patient's mouth, thereby eliminating the need for a dentist to stock various sizes of impression trays (e.g., small, medium, and large) in order to accommodate different dental arch configurations. The adjustable dental impression tray increases the accuracy of the impression cast, while decreasing dental chair time. The adjustable dental impression tray reduces the possibility of deformation of the impression cast. The adjustable dental impression tray is simple in construction, effective in operation, and inexpensive to manufacture.

Other features, objects and advantages of the present invention will become apparent from a reading of the following description as well as a study of the appended drawings.

### BRIEF DESCRIPTION OF THE DRAWINGS

A dental impression tray incorporating the features of the invention is depicted in the attached drawings which form a portion of the disclosure and wherein:

FIG. 1 is a perspective view of a dental impression tray utilized to take dental impressions.

FIG. 1A is an enlarged view of a portion of the tray of FIG. 1

FIG. 2 shows a top view of the tray of FIG. 1.

FIG. 3 shows a front view of the tray of FIG. 1.

FIG. 4 shows a side view of the tray of FIG. 1.

FIG. 5 is a perspective view of a second embodiment dental impression tray utilized to take dental impressions.

FIGS. 6-7 show perspective and top views of another tray embodiment.

FIGS. 8-9 show perspective and top views of yet another tray embodiment.

FIG. 10 shows an exemplary radiographic scanning system.

FIG. 11 shows an exemplary process for generating a digital model of a patient's teeth using the trays.

### DESCRIPTION

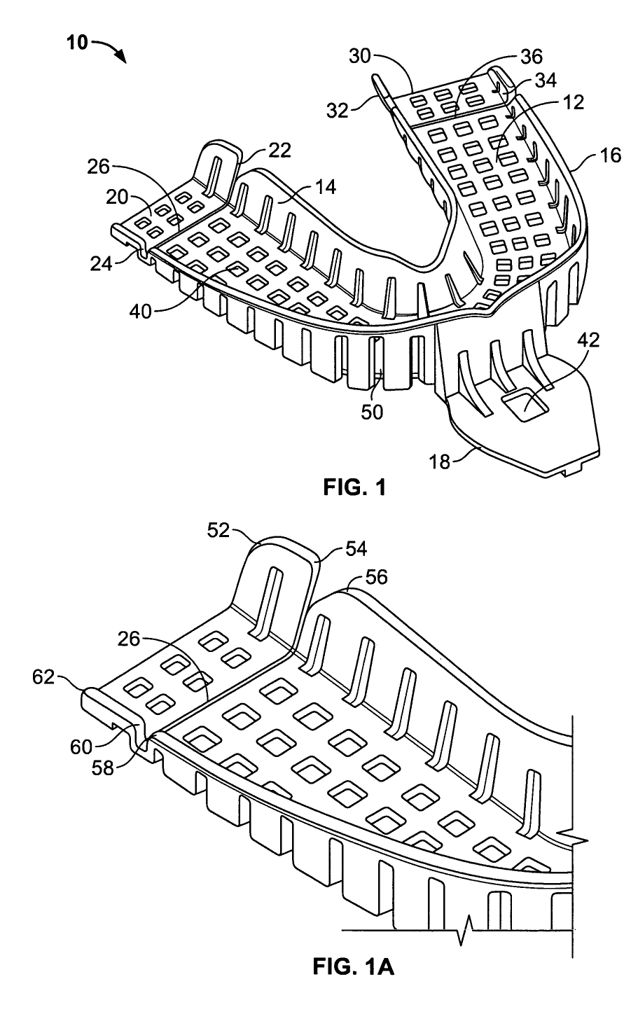

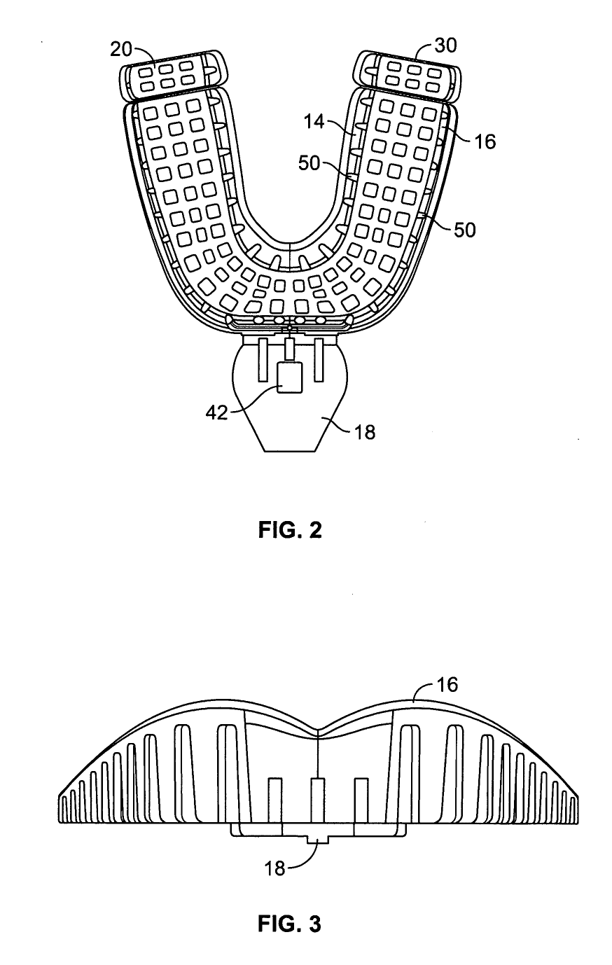

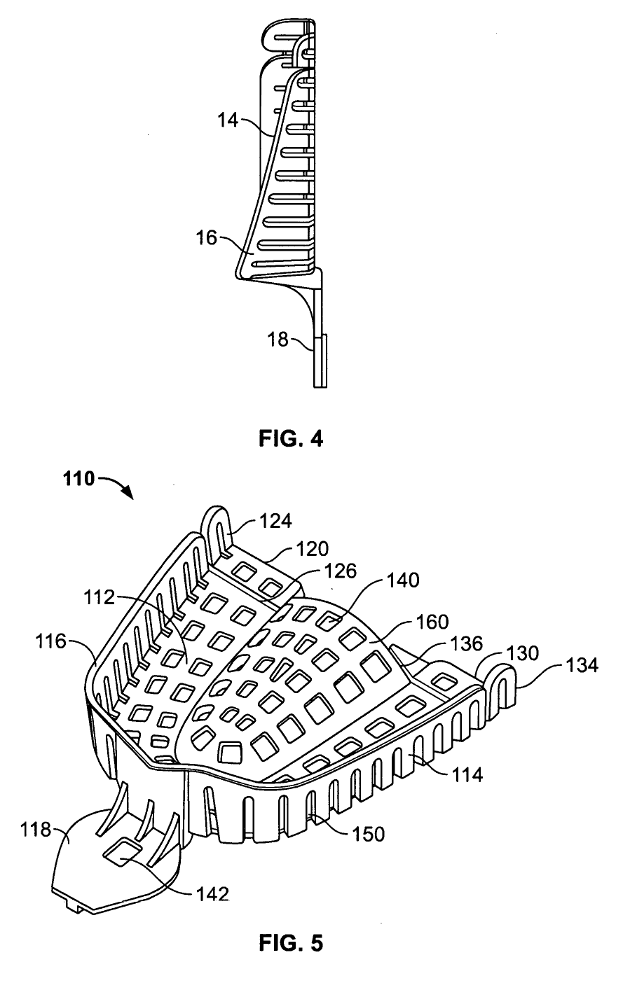

FIG. 1 is a perspective view of a dental impression tray utilized to take dental impressions. The dental tray is designated by reference number 10. FIG. 2 shows a top view of the tray 10, while FIG. 3 shows a front view of the tray 10 and FIG. 4 shows a side view of the tray 10.

The dental impression tray 10 is typically fabricated from either a thermoplastic resin or metal and includes a tray base 12, an inner tray wall 14 and an outer tray wall 16, each of which may have the same thickness, different thicknesses, or varying wall thicknesses. The inner wall 14 defines a tray recess for accommodating an individual's tongue when taking an impression, while the outer and inner tray walls 14-16 define a receiving region to receive an impression material. The tray 10 includes a tab or a handle 18 to facilitate handling by a user such as a dental professional. The base 12 and the handle 18 include one or more openings 40 which allow impression materials to flow from the receiving region as the tray is pressed against a patient's teeth. Additionally, one or more openings 50 can be formed on the walls 14-16 to allow impression materials to flow from the receiving region as well. The openings 40 and 50 may take a variety of shapes. As illustrated, the openings 40 are square, but may be rectangular or oval or rectilinear in shape. Also, the openings 50 can be triangular, semi-spherical, or semi-oval in shape.

The dental impression tray 10 also includes one or more detachable portions 20 and/or 30. Notches define one detachable portion from another. For example, notches 22 and 24 separate the portion 20 from the rest of the tray 10, while notches 32 and 34 separate the portion 30 from the tray 10. A score or a ridge 26 runs between notches 22-24, and correspondingly a ridge 36 runs between notches 32 and 34. The ridge 26 provides a structurally weakened region that allows the detachable portion 20 to be cleanly snapped off the tray 10 to shorten the tray 10 to accommodate patient physiology. Similarly, the ridge 36 allows the user to snap off the detachable portion 30 to adjust the tray 10 to accommodate the patient's jaw. In one implementation, the ridge has a depth that is about half of the thickness of the wall 14 or 16. FIG. 1A shows in more detail the portion 20. In FIG. 1A curved corners 52, 54, 56, 58, 60 and 62 of the vertical walls near ridge 26 are rounded in shape with a radius of from about 3 to 7 mm. Similarly, the inner and outer edges of these corners are proximally rounded. The rounded corners and edges significantly reduce patient discomfort when the tray comes in contact with the delicate oral tissues. FIG. 2 shows a top view of the tray 10, while FIG. 3 shows a front view of the tray 10 and FIG. 4 shows a side view of the tray 10.

While FIGS. 1-4 show an embodiment adapted to take a lower impression of the patient's dentition, FIGS. 5-8 show another embodiment adapted to take an upper impression of the patient's dentition.

FIG. 5 is a perspective view of a second embodiment dental impression tray 110 utilized to take dental impressions. In place of an inner wall, the tray 110 has a curved surface or portion 160 connecting the interior portion of a base 112. Similar to the dental impression tray 10, the tray 110 includes a tray base where the arcuate portion 160 interconnects the inner edges of the tray base and an outer tray wall. The parts of the tray 110 may have the same thickness, different thicknesses, or varying thicknesses. The tray 110 includes a tab or a handle 118 to facilitate handling by a user such as a dental professional. The base 112 includes one or more openings 140 which allow impression materials to flow from the receiving region as the tray is pressed against a patient's teeth. Additionally, one or more openings 150 can be formed on the walls 114-116 to allow impression materials to flow from the receiving region as well. The openings 140 and 150 may take a variety of shapes. As illustrated, the openings 140 are square, but may be rectangular or oval or rectilinear in shape. Also, the openings 150 can be triangular, semi-spherical, or semi-oval in shape.

The dental impression tray 110 also includes one or more detachable portions 120 and/or 130. A ridge 126 runs between notch 124 and the arcuate portion 160, and correspondingly a ridge 136 runs between notch 134 and arcuate portion 160. The ridge 126 provides a structurally weakened region that allows the detachable portion 120 to be cleanly snapped off the tray 110 to shorten the tray 110 to accommodate patient physiology. Similarly, the ridge 136 allows the user to snap off the detachable portion 130 to adjust the tray 110 to accommodate the patient's upper jaw.

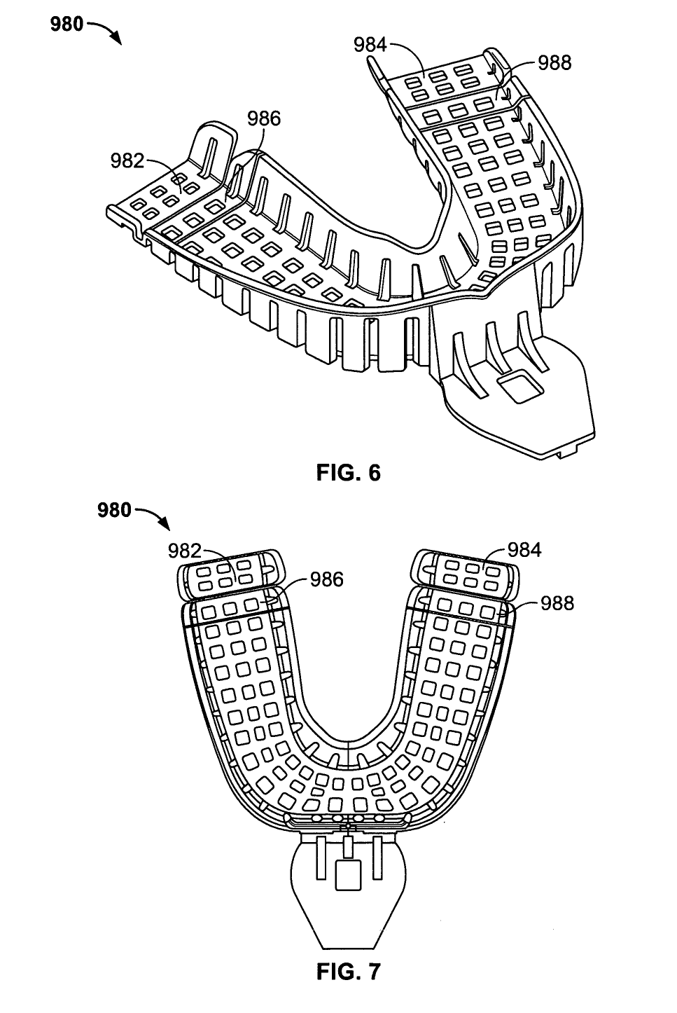

FIG. 6 shows a perspective view of another embodiment, while FIG. 7 shows a top view of the embodiment of FIG. 6. As shown therein, an exemplary dental impression tray 980 with a plurality of detachable portions 982, 984, 986 and 988, among others. In this embodiment, a user can remove one or more of the detachable portions 982-988 as desired to better conform the dental impression tray 980 to a patient's anatomy. In the embodiment of FIG. 6, the detachable portions 982-988 are removed in sequence that is the end portion must be removed before the next portion can be removed. To illustrate, the portion 982 should be removed so expose the portion 986 for removal. Similarly, the portion 984 should be removed to allow the user access to the portion 988.

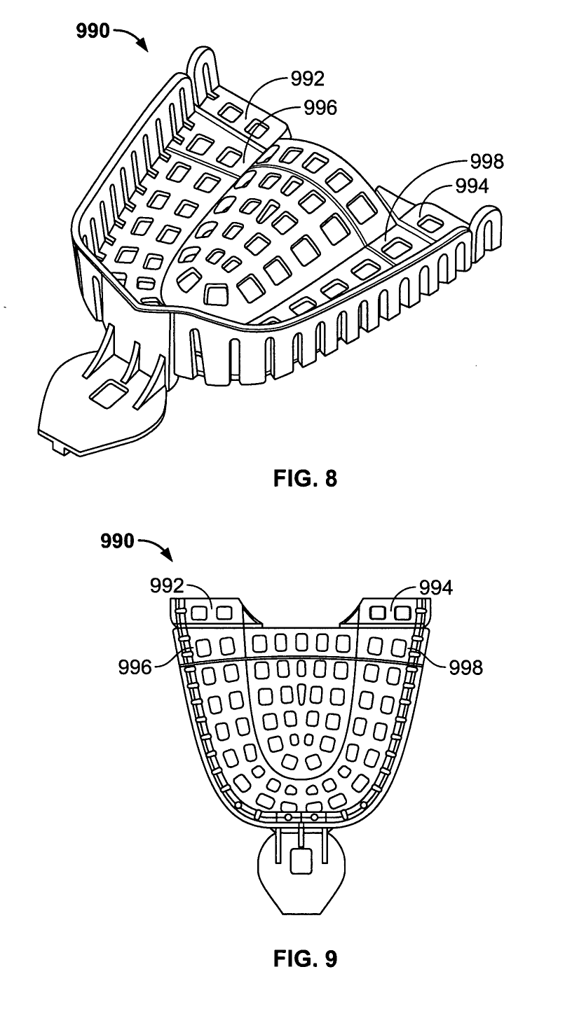

FIG. 8 shows a perspective view of yet another embodiment, while FIG. 9 shows a top view of the embodiment of FIG. 8. As shown in FIG. 8, an exemplary dental impression tray 990 with a plurality of detachable portions 992, 994, 996 and 998, among others. In this embodiment, a user can remove one or more of the detachable portions 992-998 as desired to better conform the dental impression tray 990 to a patient's anatomy. In the embodiment of FIG. 8, the detachable portions 992-998 are removed in sequence that is the end portion must be removed before the next portion can be removed. To illustrate, the portion 992 should be removed so expose the portion 996 for removal. Similarly, the portion 994 should be removed to allow the user access to the portion 998.

A variety of thermoplastics may be used to manufacture an acceptable dental impression tray. The nature of the dental tray resin is not particularly critical as long as it is of a suitable medical grade quality, provides sufficient rigidity when injection molded and is compatible with the x-ray attenuating agent. Suitable thermoplastic resins include but are not limited to polyurethane, polyester, polycarbonate, ABS and polystyrene.

In one implementation, a radiopaque agent is added to the thermoplastic resins to attenuate the intensity of a scanner's X-ray beam and to improve the quality of the scan data. An example of a thermoplastic polyurethane resin that may be compounded with a radiopaque agent and may be injection molded to produce dental impression trays is Tecoplast, for example OP 800 B03 BL 294.

The radiopacity of the thermoplastic impression tray depends on its atomic number and density which may be controlled by compounding a radiopaque agent(s) into the thermoplastic resin. Suitable radiopaque agents include barium sulfate, calcium carbonate, calcium chloride, sodium carbonate, magnesium sulfate, bismuth trioxide, bismuth subcarbonate, bismuth oxychloride and the heavy metal powder tungsten, gold, platinum, silver. The type and amount of radiopacifier depends on the thermoplastic resin, the impression tray wall thickness, the type of impression material used to take the dental impression as well as the X-ray source and detector. For the computed tomography scanning method employed it is recommended that the X-ray characteristics of the dental tray be formulated so that its radiopacity matches or closely approximates the radiopacity of the impression material. In general the attenuation factor of the impression tray should not exceed the attenuation factor for the impression material by more than 50%. For example, the x-ray attenuation factor for a typical commercially available polyvinylsiloxane impression material is about 1.7 when compared to a water standard which is 1.0. A dental impression tray fabricated from a medical grade polyurethane thermoplastic resin without any radiopaques additives has a X-ray attenuation factor of about 0.4-0.5. This value is too low and will not allow for optimum resolution of the two materials and consequently the computer algorithm will not properly reconstruct the dental impression image. In contrast, a polyurethane resin or polycarbonate resin formulated with 3%+/−1% of the radiopaque agent barium sulfate or 25%+/−3% calcium carbonate has a X-ray attenuation factor of 1.4 relative to the water standard 1.0. This attenuation factor is close to the attenuation factor for the PVS resin and allows for accurate reconstruction of the dental image.

The impression tray 10 or 110 and impression material are then introduced into a patient's mouth. An impression is made by the dentist positioning the impression tray and impression material over the patient's teeth and applying pressure so that the impression material disperses around the teeth and dental arch while the dental impression material is curing. To obtain an accurate impression, the impression material must be pushed against the teeth and gums, so that there are no gaps between the teeth and gums and the impression material. To capture the patient's upper arch, the tray is inserted with the base 12 facing down. To capture the patient's lower arch, the tray is inverted so that the tray base 12 is disposed upwardly. It will be appreciated that the tray interior accommodates a teeth impression material such as wax. After the impression has been made by virtue of the dentist pressing the patient's teeth into the impression material, the tray and impression material are removed from the mouth after the impression material have cured and will not flow or deform. Excess impression material may be trimmed from the lingual recess of the dental impression tray.

A wide range of impression materials is available for taking dental impressions. The major chemical classes of elastomeric impression materials include irreversible hydrocolloids, reversible hydrocolloids, polysulfide, polyether, condensation reaction silicones and addition reaction silicones. Of these, irreversible hydrocolloids, addition reaction silicones and polyethers are the most popular materials used by professionals for taking dental impressions. Alginates are examples of irreversible hydrocolloids formed by combining the sodium salt of alginic acid, calcium sulfate and water. Commercially available alginate impression materials include Jeltrate® (Dentsply/Caulk), Coe Alginate® (Coe) and Kromopan® (Lascod S.p.A.). Polyethers come as a two part system consisting of base and catalyst pastes. The base contains a polyether with imine end groups and the catalyst contains an aromatic sulfonic acid. These components may be either mixed by hand or dispensed from a dual chambered cartridge that automatically mixes the correct proportions of base and catalyst material. Commercially available polyether materials include Impregum F® (ESPE), Permadyne® (ESPE) and Polyjel® (Dentsply/Caulk). Like polyethers, addition reaction silicones are a two part system consisting of base and catalyst pastes. These materials are also called polyvinylsiloxanes (abbreviated PVS) or vinyl siloxanes since vinyl groups are present as terminal end groups in one paste. The other paste contains terminal hydrogens. When mixed together they form a highly cross-linked elastomeric material which recovers well from deformation. Commercially available PVS impression materials include Splash® (Discus Dental), Aquasil® (Dentsply/Caulk) and Dimension® (ESPE).

Depending on the radiopacity of the tray and impression materials in some applications it may be useful to directly compound a radiopaque material into the impression material to achieve a desired attenuation. The radiopaque material may be formulated into the impression materials described previously. For example, for powdered alginate materials the radiopaque compound could be dry blended into the component mixture. For polyethers and polyvinylsiloxanes that come as a two part system the radiopaque material would be mixed and dispersed with either the base or catalyst pastes. An impression material formulated with a radiopaque material may be used to capture full arch, dual arch, single arch, partial arch impressions or bite relationship impressions. Furthermore, in addition to being premixed into the impression material, the radiopaque material may be in the form of a spray, dip, or powder layer that is used to coat the surface of the impression material in order to make the surface more visible to the scanner after the impression has been captured, but prior to the scan.

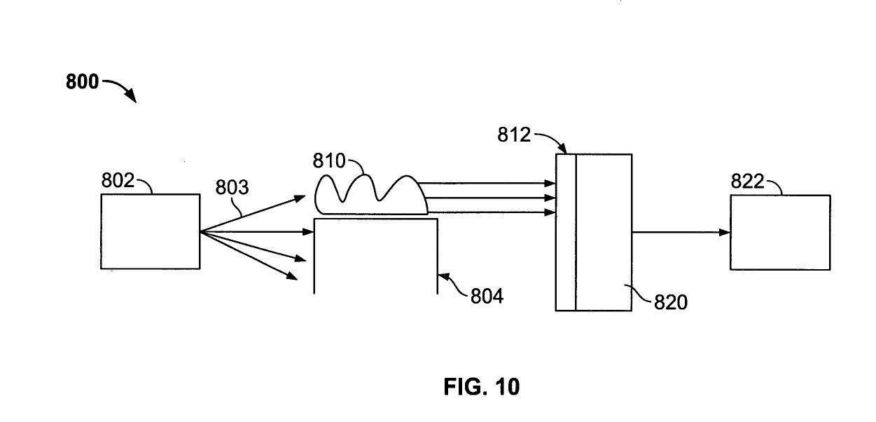

The tray and the impression material are eventually provided to a scanner to obtain 3-D dental information for the patient. FIG. 10 shows one embodiment of the scanner, which in this embodiment is an X-ray scanner. The scanner 800 has a rotating table 804 including a table top that has sufficient space for one or two impressions 810 to rest on it. The impression 810 can be irradiated by a flat fan-shaped X-ray beam 803 emitted by an X-ray source 802. The radiation is swept by the impression 810 and passes through a scintillator 812. Radiation transmitted by the scintillator 812 is measured by an X-ray detector 820. The detector 820 performs an analog to digital conversion and provides this information to a computer 822. The computer 822 captures on cross sectional scan and instructs the rotating table 804 to rotate to its next position and another scan is performed until the entire impression 810 is scanned. The X-ray source 802, the scintillator 812, the detector 820 and the rotatable table 804 thus obtains an image of a cross-section of (a part of) the impression 810 by computer tomography (CT). The CT system scans impressions of patients' teeth and eliminates the need to create a plaster model for each jaw. Software on the computer 822 automatically extracts a positive model out of the scan data. The upper and lower jaw will then be put together using the information from the scan data of a wax bite. In one embodiment, the scanner 800 utilizes a technique called “cone beam reconstruction.”

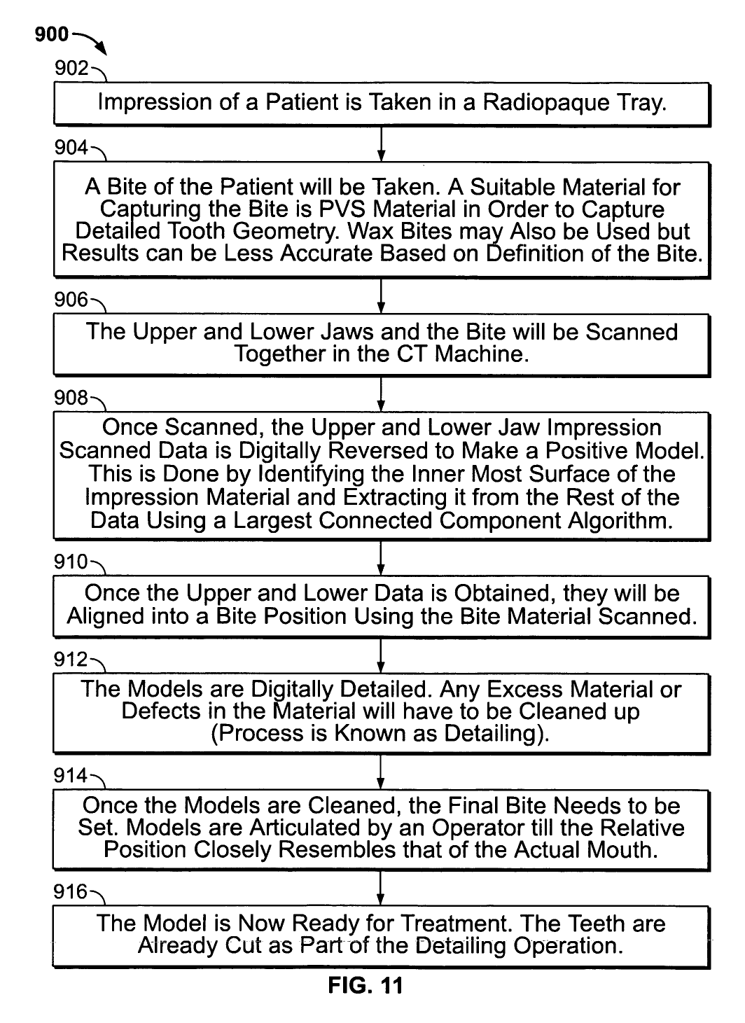

FIG. 11 shows one process 900 for digitally scanning and generating a model of the patient's teeth for treatment. The process 900 is as follows:
1. Impression of a patient is taken in a radiopaque tray (902).
2. A bite of the patient will be taken. A suitable material for capturing the bite is PVS material in order to capture detailed tooth geometry. Wax bites may also be used but results can be worse based on definition on the bite (904).

3. The upper, lower and the bite will be scanned together in the CT machine (906).
4. Once scanned, the upper and lower impression scanned data is digitally reversed to make a positive. This is done by identifying the inner most surface of the impression material and extracting it from the rest of the data using a largest connected component algorithm (908).
5. Once the upper and lower data is obtained, they will be aligned into a bite position using the bite material scanned (910).
6. The models are digitally detailed. Any excess material or defects in the material will have to be cleaned up (process is known as detailing) (912).
7. Once the models are cleaned, the final bite needs to be set. Models are articulated by an operator till the relative position closely resembles that of the actual mouth (914).
8. The model is now ready for treatment. The teeth are already cut as part of the detailing operation (916).

In one aspect, a method creates a digital model of a patient's teeth by creating a radiographic impression of the patient's teeth; scanning the impression using an X-ray source; and generating the digital model with scanned data. Implementations of the above aspect may include one or more of the following. The radiation source may be passed through a scintillator. The output of the scintillator is then digitized. The impression of the teeth can be taken in a dental tray. A bite impression of the patient can also be taken. The bite impression is taken using a PVS material or a wax bite. The upper teeth impression, a lower teeth impression and a bite impression can be scanned together. The data for the upper and lower impression scan data to make positive data can be digitally reversed. The digital reversing identifies inner surfaces of an impression material and extracting the inner surfaces using a largest connected component algorithm. The data can be aligned into a bite position using the bite material scanned. The digitized teeth data can be digitally detailed. A final bite can be determined. The digital model can be virtually articulated. A computer representation of a masticatory system of the patient can be generated and the computer can determine an occlusion from the computer representation of the masticatory system. The system can register a model of the upper and lower teeth with a model of the masticatory system; simulate the motion of the jaws to generate contact data between the upper and lower teeth; and place teeth in a final position based on the contact data. The system can apply kinematics to the model of the teeth. A constrained motion can be applied to the model of the tooth. The position of the tooth can be determined according to a measure of undesirability. The measure of undesirability is a function of one or more of Peer Assessment Rating (PAR) metrics, distance-based metrics and shape-based metrics. A library of motions can be applied to the digital model of the teeth. The library of motions includes protrusive motion, lateral motion, and tooth-guided motion. Physical forces can be applied to the teeth model.

In another aspect, an apparatus to create a digital model of a patient's teeth includes a radiation source; a scintillator to receive the radiation from the radiation source; a radiation detector coupled to the scintillator; a rotatable table positioned between the radiation source and the scintillator, the table being adapted to support an impression of the patient's teeth; and a computer coupled to the detector to generate the digital model with scanned data. A fabrication machine can be driven by the computer to generate a plurality of appliances, wherein the appliances comprise polymeric shells having cavities and wherein the cavities of successive shells have different geometries shaped to receive and resiliently reposition the teeth from one arrangement to a successive arrangement. Such systems are described in U.S. Pat. Nos. 6,633,789; 6,629,840; 6,626,666; 6,621,491; 6,607,382; 6,602,070; 6,582,229; 6,582,227; 6,572,372; 6,554,611; 6,524,101; 6,514,074; 6,499,997; 6,497,574; 6,488,499; 6,485,298; 6,471,511; 6,463,344; 6,457,972; 6,454,565; 6,450,807; 6,409,504; 6,406,292; 6,398,548; 6,394,801; 6,390,812; 6,386,878; 6,386,864; 6,371,761; 6,318,994; 6,309,215; 6,299,440; 6,227,851; 6,227,850; 6,217,325; 6,210,162; 5,975,893, the contents of which are hereby incorporated by reference.

Additionally, the techniques described here may be implemented in hardware or software, or a combination of the two. The techniques may be implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices.

Each program can be implemented in a high level procedural or object-oriented programming language to operate in conjunction with a computer system. However, the programs can be implemented in assembly or machine language, if desired. In any case, the language may be a compiled or interpreted language. Each such computer program can be stored on a storage medium or device (e.g., CD ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

The ridges can also be creases or lines of perforations running horizontally, vertically, or angled through the tray. Alternatives to the ridges to allow the detachable portions to be removed such as flanges are within the scope of the invention.

While the invention has been shown and described with reference to an embodiment thereof, those skilled in the art will understand that the above and other changes in form and detail may be made without departing from the spirit and scope of the following claims.

1. A dental tray adapted to receive a dental impression material thereon, comprising:
a base having a plurality of prongs, the base having one or more openings to allow flowing of the dental impression material;
a first wall extending from one side of the base, the first wall having one or more openings to allow flowing of the dental impression material; and at least one tearable portion formed on one end of one prong, the tearable portion being removable to shorten the prong length.

2. The dental tray of claim 1, wherein the detachable portion comprises curved corners.

3. The dental tray of claim 1, wherein the first wall comprises a curved edge.

4. The dental tray of claim 1, wherein the first wall has a fixed wall length.

5. The dental tray of claim 1, wherein the first wall has an adjustable wall length.

6. The dental tray of claim 1, wherein the number of openings are adjustable.

7. The dental tray of claim 1, further comprising a second wall extending from the other side of the base, the second wall having openings there through.

8. The dental tray of claim 7, wherein the second wall has an adjustable wall length.

9. The dental tray of claim 1, further comprising a containing a radiopaque material.

10. The dental tray of claim 1, further comprising an arcuate portion interconnecting the plurality of prongs.

11. The dental tray of claim 10, wherein the arcuate portion comprises one or more openings.

12. The dental tray of claim 1, wherein the tray is adapted to be positioned in a radiographic scanner.

13. A system to capture upper and lower dental impressions of a patient, comprising:
an upper dental tray adapted to receive a dental impression material thereon, including:
a base having a plurality of prongs, the base having one or more openings to allow flowing of the dental impression material;
first and second walls extending from both sides of the base, the walls having one or more openings to allow flowing of the dental impression material;
a lower dental tray adapted to receive a dental impression material thereon, including:
a lower base having a plurality of prongs, the lower base having one or more openings to allow flowing of the dental impression material;
a lower wall extending from one side of the base, the lower wall having one or more openings to allow flowing of the dental impression material;
an arcuate portion interconnecting the plurality of lower prongs; and at least one tearable portion formed on at least one end of one prong, the tearable portion being removable to shorten the prong length.

14. The system of claim 13, wherein the base and walls contain a radiopaque material.

15. The system of claim 13, wherein at least one wall has a fixed wall length.

16. The system of claim 13, wherein at least one wall has an adjustable wall length.

17. The system of claim 13, wherein the number of openings are adjustable.

18. A dental impression system, comprising:
a dental tray containing a radiopaque material adapted to receive a dental impression material thereon, including:
a base having a plurality of prongs, the base having one or more openings to allow flowing of the dental impression material;
a wall extending from one side of the base, the wall having one or more openings to allow flowing of the dental impression material; and
a container to house the radiographic tray, the container and the dental tray being adapted to be scanned by a radiographic scanner.

19. The system of claim 18, wherein the radiographic scanner comprises
a radiation source;
a scintillator to receive the radiation from the radiation source;
a radiation detector coupled to the scintillator; and
a rotatable table positioned between the radiation source and the scintillator, the table being adapted to support the container.

20. The system of claim 18, further comprising a computer coupled to the radiation detector to generate a digital model with scanned data.

21. The system of claim 18, further comprising an impression material having a radiopaque material.

22. The system of claim 21, wherein the radiopaque material is incorporated into the dental impression material for full arch, dual arch, single arch, partial arch, or bite relationship capture.

23. The system of claim 21, wherein the dental impression includes one of the following: polyvinlysiloxane (PVS), alginate, polysulfide, acrylic, hydrocolloid, polyether and bite registration paste.

24. The system of claim 21, wherein the radiopaque material comprises a spray, a dip, or a powder layer used to coat surface of the impression material in order to make the surface more visible to the scanner after the impression has been captured.
